(19) United States
(12) Patent Application Publication
(10) Pub. No.: US 2015/0369192 A1
(43) Pub. Date: Dec. 24, 2015

(54) Low Soot Dual Tip Variable Conicity Injector

(71) Applicant: Caterpillar Inc., Peoria, IL (US)

(72) Inventors: Xinyu Ge, Peoria, IL (US); Yongli Qi, Peoria, IL (US)

(21) Appl. No.: 14/311,646

(22) Filed: Jun. 23, 2014

(51) Int. Cl. F02M 61/10

(52) U.S. Cl. CPC F02M 61/10

(57) ABSTRACT

A fuel injection apparatus for use in a compression ignition engine comprises a first injector tip defining a first set of outlet orifices therethrough and a second injector tip defining a second set of outlet orifices therethrough. The first set of outlet orifices has a first conicity and the second set of outlet orifices has a second conicity. The first conicity is different from the second conicity.

### TECHNICAL FIELD

The present disclosure relates generally to internal combustion engines, and relates more particularly to a direct injection compression ignition engine with a dual tip fuel injector and associated methods of fuel injection.

### BACKGROUND

Internal combustion engines burn a hydrocarbon-based fuel or another combustible fuel to convert the potential or chemical energy therein to mechanical power that can be used to perform work. Exhaust emissions from internal combustion engines may include constituents subject to government regulations. Design parameters of fuel injectors may impact these emissions by affecting fuel spray quality.

U.S. Pat. No. 6,422,199 (“the '199 patent”), entitled “Fuel Injector,” purports to address the problem of particulate emissions. The '199 patent describes a fuel injector having first and second valve needles and corresponding first and second outlet openings. The design of the fuel injector disclosed in the '199 patent, however, may produce particulate emissions that are still greater than optimum. Accordingly, there is a need for an improved fuel injector.

### SUMMARY

In one aspect of the disclosure, a fuel injection apparatus for use in a compression ignition engine includes a first injector tip defining a first set of outlet orifices therethrough and a second injector tip defining a second set of outlet orifices therethrough. The first set of outlet orifices has a first conicity and the second set of outlet orifices has a second conicity. The first conicity is different from the second conicity.

In another aspect of the disclosure, the disclosure describes an engine includes an engine housing having at least one combustion chamber therein, a piston movable within the at least one combustion chamber and configured to compress air therein to a compression ignition condition, and a fuel injection apparatus. The fuel injection apparatus defines at least a portion of the at least one combustion chamber. The fuel injection apparatus has a first injector tip defining a first set of outlet orifices therethrough and a second injector tip defining a second set of outlet orifices therethrough. The fuel injection apparatus is configured to selectively inject fuel into the combustion chamber via at least one of the first injector tip and the second injector tip. The first set of outlet orifices has a first conicity and the second set of outlet orifices has a second conicity that is different from the first conicity.

In yet another aspect of the disclosure, a method of operating an internal combustion engine includes a step of injecting a first quantity of fuel into a combustion chamber of the engine via a first set of outlet orifices having a first conicity. The method further includes injecting a second quantity of fuel into the combustion chamber via a second set of outlet orifices having a second conicity. The method also includes igniting and burning the first quantity of fuel and the second quantity of fuel. The first conicity is different from the second conicity.

### BRIEF DESCRIPTION OF THE DRAWINGS

FIG. 1 is a schematic illustration of a system including an engine, a fuel injector, and an exhaust system, according to an aspect of the disclosure;

FIG. 2 is a schematic illustration of a fuel injection system, according to an aspect of the disclosure;

FIG. 3A is a schematic cross-sectional view of a fuel injector, according to an aspect of the disclosure;

FIG. 3B is a schematic bottom view of the fuel injector shown in FIG. 3A;

FIG. 4A is a schematic cross-sectional view of a fuel injector, according to an aspect of the disclosure;

FIG. 4B is a schematic bottom view of the fuel injector shown in FIG. 4A;

FIG. 5A is a schematic cross-sectional view of a fuel injector, according to an aspect of the disclosure;

FIG. 5B is a schematic bottom view of the fuel injector shown in FIG. 5A;

FIG. 6A is a schematic cross-sectional view of a fuel injector, according to an aspect of the disclosure; and

FIG. 6B is a schematic bottom view of the fuel injector shown in FIG. 6A.

### DETAILED DESCRIPTION

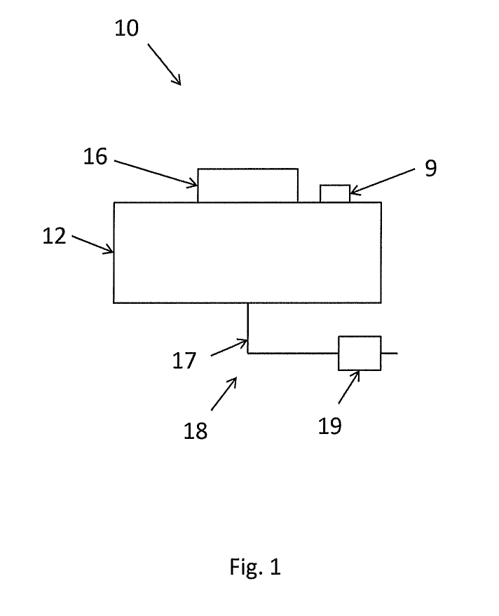

Referring to FIG. 1, an engine system 10 includes an engine 12 which is connected to a fuel injector apparatus 16 and an exhaust system 18. After fuel is injected into engine 12 by fuel injector apparatus 16 and burned, the combustion products are then exhausted from the engine 12 along an exhaust path 17 of exhaust system 18 that leads outside the engine 12 to an ambient environment of the engine 12. Exhaust path 17 may include a diesel particulate filter 19 that removes particulates from the exhaust gas.

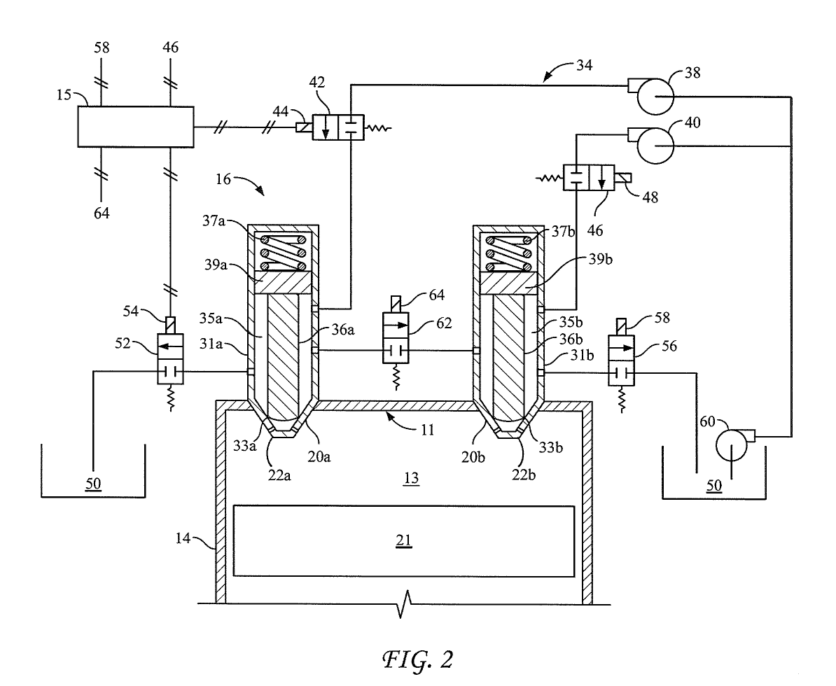

With reference to FIG. 2, engine 12 further includes at least one cylinder 14 with a piston 21, disposed at least partially therein. Cylinder 14 and the piston 21 at least partially define a combustion chamber 13. Piston 21 may be coupled with a crankshaft via a connecting rod or other connecting structure known in the art. Engine 12 may be a compression ignition engine, for example a diesel engine. Alternatively, engine 12 may be a spark ignition engine, or any other type of reciprocating engine known in the art. Engine 12 may include at least one sensor 9 configured to sense values indicative of engine speed, engine load, combinations thereof, or any other engine operating parameter known in the art, and output corresponding signals indicative of an engine operating parameter to a controller 15.

Engine 12 might be constructed having only a single cylinder and single piston. Alternatively, engine 12 may include a plurality of cylinders and pistons, such as four, eight, 10, 12, or 16 or more cylinders depending upon the application. The arrangement of cylinders in engine 12 may include any known configuration, such as a V-pattern, in-line, radial, opposed, etc. In many aspects, size and space will be at a premium and thus a V-pattern engine, for example, may be a practical design.

Fuel injection apparatus 16 works in conjunction with a fuel delivery system 34 to deliver fuel to each combustion chamber 13 using first and second injector bodies 31a, 31b. Injector bodies 31a, 31b each include an injector tip 20a, 20b, respectively, at a proximate end, proximate to the cylinder 14, and a fuel chamber 35a, 35b at a distal end, distal to the cylinder 14. Injector tips 20a, 20b are each in selective fluid communication with fuel chambers 35a, 35b, respectively. Fuel flow to first fuel injector tip 20a and second fuel injector tip 20b is controlled by a valve 36a, 36b, respectively, such as a needle valve. Valves 36a, 36b are actuated between an open position, when the valve is lifted and injector tips 20a, 20b are in fluid communication with fuel chambers 35a, 35b, and a closed position, when the valve is lowered and injector tips 20a, 20b are blocked from fluid communication with fuel chambers 35a, 35b, by action of springs 37a, 37b and pistons 39a, 39b, for example. In the closed position, valves 36a, 36b press against a sealing surface 33a, 33b of the injector bodies 31a, 31b so as to block communication between the fuel chambers 35a, 35b and the injector tips 20a, 20b. Sealing surfaces 33a, 33b, in combination with the distal ends of injector bodies 31a, 3 lb define first and second fuel chambers 35a, 35b which each have a first volume, respectively. Sealing surfaces 33a, 33b, in combination with the proximal ends of injector bodies 31a, 31b define first and second injector tips 20a, 20b which each have a second volume, respectively. Valves 36a, 36b may alternatively be actuated by a solenoid or other valve actuation structure known in the art. Additionally, a fuel injection apparatus with more than two fuel injector tips 20a, 20b is also contemplated.

Fuel injector tips 20a, 20b further define a portion of the combustion chamber 13. Fuel injector tips 20a, 20b may be flush with a cylinder head 11 of the cylinder 14 or fuel injector tips 20a, 20b may extend through the cylinder head 11 and project at least partially into the combustion chamber 13. Each fuel injector tip 20a, 20b has a plurality of outlet orifices 22a, 22b through which fuel is injected into a corresponding combustion chamber 13.

Fuel chambers 35a, 35b are each in fluid communication with fuel delivery system 34, which includes high pressure pumps 38, 40, reservoir 50, and low pressure pump 60. Flow of fuel between the reservoir 50 and the engine 12 is controlled by controller 15 that actuates valves that are disposed throughout the fuel delivery system 34, and may further actuate the low pressure pump 60 and one or more of the high pressure pumps 38, 40.

High pressure pump 38 delivers fuel to injector tip 20a via a first fuel chamber 35a. Delivery of fuel to injector tip 20a is controlled by a valve 42, which is opened and closed by an actuator 44. Similarly, delivery of fuel to injector tip 20b from high pressure pump 40 via a second fuel chamber 35b is controlled by a valve 48, which is opened and closed by actuator 46. First fuel chamber 35a may be in selective fluid communication with second fuel chamber 35b via a valve 62 which is opened and closed by actuator 64.

Fuel chambers 35a, 35b are each also in fluid communication with a fuel reservoir 50. Fuel may flow from fuel chamber 35a to fuel reservoir 50 via valve 52, which is opened and closed by actuator 54. Similarly, fuel may flow from fuel chamber 35b to fuel reservoir 50 via valve 56, which is opened and closed by actuator 58. Valves 52, 56 may be referred to as low pressure return valves. One or more low pressure pumps 60 may deliver fuel from the reservoir 50 to one or more of the high pressure pumps 38, 40.

Any of the actuators 44, 48, 54, 58, 64 may be connected to and controlled by controller 15. Actuators 44, 48, 54, 58, 64 may be solenoid actuators, pneumatic actuators, hydraulic actuators, or other actuator known in the art.

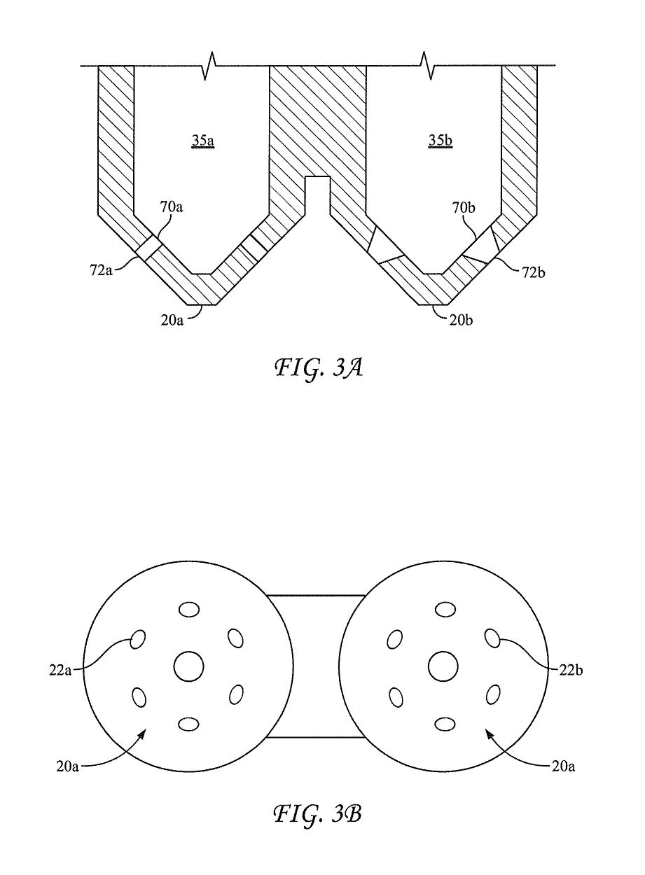

With reference now to FIGS. 3A-6B, orifices 22a, 22b of injection tips 20a, 20b may have various different geometries. Specifically, orifices 22a and 22b may have different conicities. Conicity for each orifice may be quantified based on a difference between inlet diameter 70a, 70b and outlet diameter 72a, 72b over a length of the orifice ((inlet diameter 70−outlet diameter 72)/length). The length of the orifice may extend from the inlet of the orifice to the exit of the orifice, which may coincide with a thickness of the corresponding injector body local to the orifice.

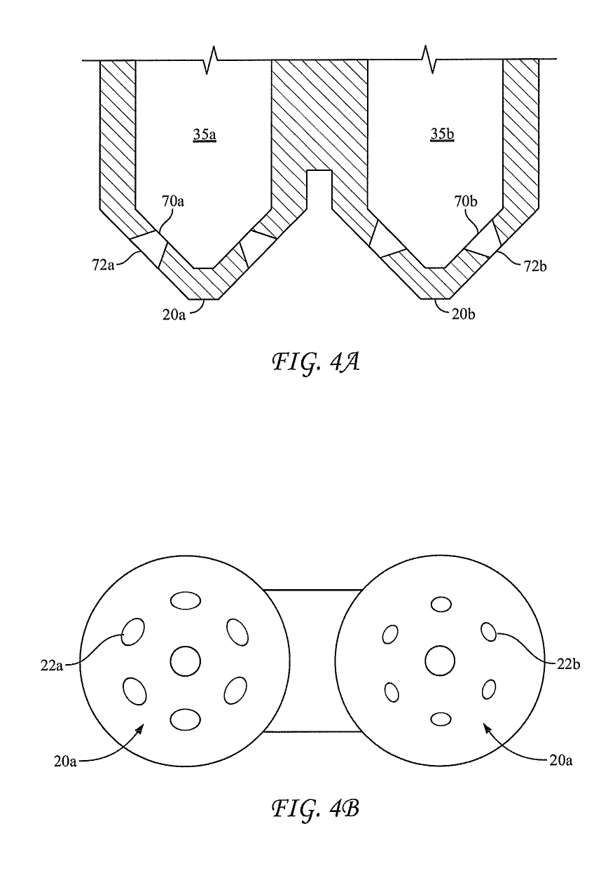

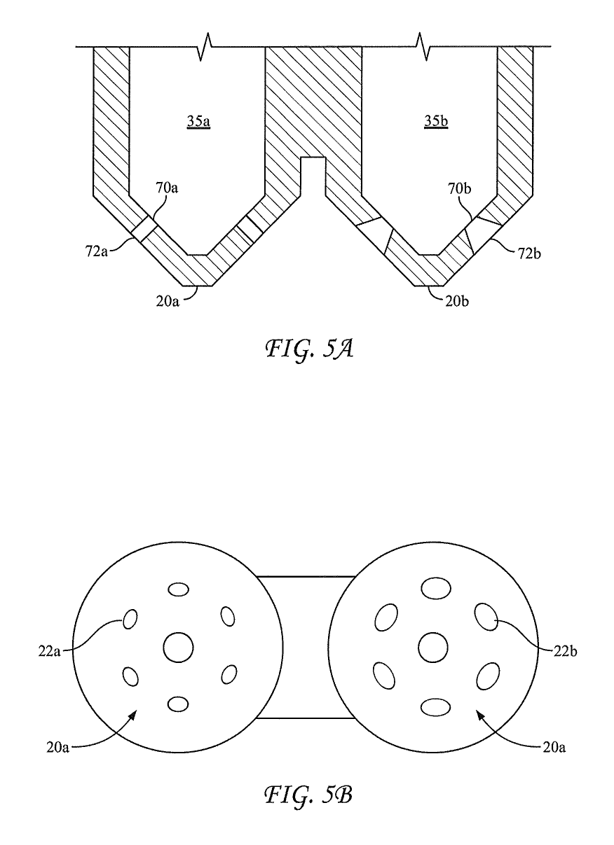

For example, with reference to tip 20a shown in FIG. 3A, orifices 22a have a straight conicity such that the inlet diameter 70a minus the outlet diameter 72a divided by the length is zero. In contrast, with reference to tip 20b shown in FIG. 3A, orifices 22b have a converging conicity, such that the inlet diameter 70b minus the outlet diameter 72b divided by the length is greater than zero. With reference now to FIG. 4A, orifices 22a may also have a diverging conicity, such that the inlet diameter 70a minus the outlet diameter 72a divided by the length is less than 0. Accordingly, fuel injector apparatus 16 may have one tip 20a with orifices 22a having a straight conicity and one tip 20b with orifices 22b having a converging conicity (as shown in FIGS. 3A and 3B), one tip 20a, 20b with orifices 22a, 22b having a diverging conicity and one tip 20a, 20b with orifices 22a, 22b having a converging conicity (as shown in FIGS. 4A and 4B), or one tip 20a, 20b with orifices 22a, 22b having a straight conicity and one tip 20a, 20b with orifices 22a, 22b having a diverging conicity (as shown in FIGS. 5A and 5B). For example, one tip 20a, 20b may have orifices with a conicity in the range of −0.5 to +0.5 and one tip with orifices with a conicity in the range of 1.0 to 2.0.

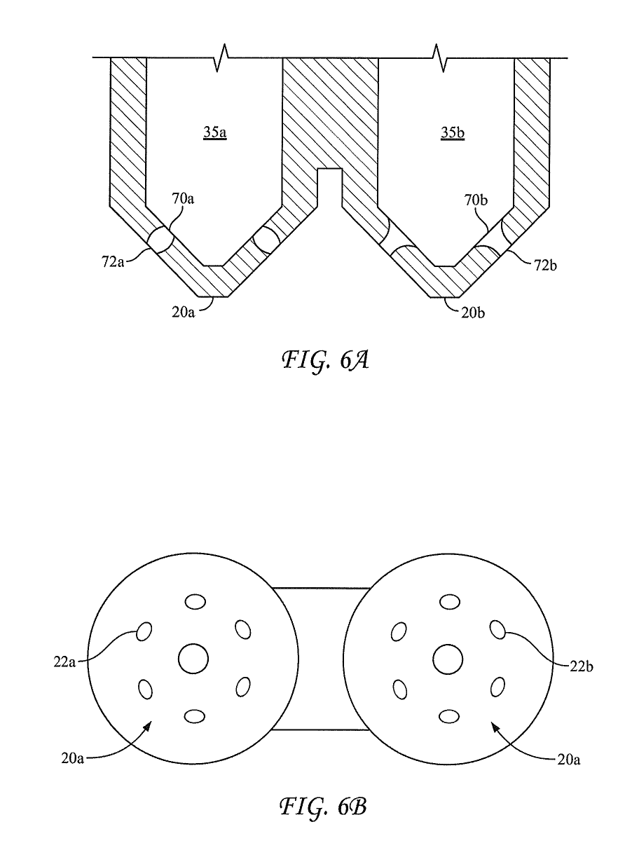

Geometry of orifices 22a, 22b may further vary in terms of whether the walls of the orifices are concave, convex, or straight. While FIGS. 3A, 4A, and 5A show straight orifice walls, orifices 22a in FIG. 6A have concave walls and orifices 22b have convex walls.

While each tip 20a, 20b may have orifices 22a, 22b that are identical to each other in terms of conicity and orifice wall geometry, each tip 20a, 20b may also have orifices 22a, 22b that are different from one another. For example, a tip 20a, 20b may have some orifices with a conicity of zero and straight walls and other orifices with a converging conicity and convex walls.

In addition to conicity and orifice wall geometry, the number of orifices 22a, 22b in tips 20a, 20b, respectively, may vary. For example, while each tip 20a, 20b in FIGS. 3A-6B are shown with six orifices, fuel injector apparatus 16 may include one tip 20a, 20b with five to seven orifices and another tip 20a, 20b with six to eight orifices, for example. However, it will be appreciated that the number of the orifices in each tip 20a, 20b may be selected from any number to suit a particular application.

Orifices 22a, 22b may be formed by laser drilling holes in injector tip 20a, 20b. Alternatively, other methods of forming orifices may be used. For instance, orifices 22a, 22b may be formed via coating or plating larger holes down to the desired diameter, or casting ceramic injector nozzles with small wires therein, and burning the wires away during curing of the nozzles.

### INDUSTRIAL APPLICABILITY

Design parameters of a fuel injector, such as the geometry of fuel injector apparatus 16 and the configuration of fuel delivery system 34 may have significant impacts on exhaust emissions. These parameters can affect not only fuel spray quality, but also timing of main injection and post injection shots, which in turn may affect concentrations of particular constituents in the exhaust emissions. Certain configurations of the fuel injector apparatus 16 described herein can reduce particulate matter (PM) emissions by 20-30%. In-cylinder PM emission reduction at these levels may obviate the need for a diesel particulate filter 19 in order for the engine 12 to meet a particular PM emissions target. Additionally, such configurations may also improve brake specific fuel consumption through enhanced combustion performance, reduction of exhaust backpressure, or combinations thereof.

With reference again to FIG. 2, during operation, actuator 44 is energized to open valve 42 so as to selectively admit a flow of fuel from the high pressure pump 38 into the fuel chamber 35a. Fuel pressure in chamber 35a acts on the piston 39a to compress the spring 37a, thereby translating the valve 36a in the distal direction relative to combustion chamber 13 to an open position such that fuel passes through orifices 22a of injector tip 20a. High pressure pump 38 may be configured to deliver fuel to tip 20a at a pressure that is sufficient to atomize the fuel.

When actuator 44 is energized, actuator 54 may be de-energized so as to close valve 52. Actuator 64 may also be de-energized such that the only flow path for fuel from the fuel chamber 35a is through orifices 22a. Actuator 44 is then de-energized, which closes valve 42. Flow of fuel from fuel chamber 35a continues until valve 36a seats and stops fuel from high pressure pump 38 from entering tip 20a. When actuator 44 is de-energized, actuator 54 may be energized, which opens valve 52 so that high pressure fuel in injector body 31a may pass into reservoir 50. Actuator 64 may also be energized alternatively or in combination with actuator 54, which opens valve 62 so that high pressure fuel in injector body 31a may flow into injector body 31b. Valve 36a also lowers to its closed position, with or without opening of valves 52, 62. Reduction of pressure within injector body 31a when valves 52, 62 open augments movement of valve 36a to its closed position. When actuator 64 is de-energized and valve 62 is closed, pressure in chamber 35b is not affected by pressure changes in chamber 35a. With chamber 35b separated from chamber 35a by valve 62, actuator 48 may be energized before, during, or after fuel injection through orifices 22a so as to cause fuel injection through orifices 22b.

Fuel may also be injected through injector tip 20b from high pressure pump 40. Specifically, actuator 48 is energized to open valve 46 so as to selectively admit a flow of fuel from the high pressure pump 40 into the fuel chamber 35b. Fuel pressure in chamber 35b acts on the piston 39b to compress the spring 37b, thereby translating the valve 36b in the distal direction relative to combustion chamber 13 to an open position such that fuel passes through orifices 22b of injector tip 20b.

When actuator 48 is energized, actuator 58 may be de-energized so as to close valve 56. Actuator 64 is also de-energized such that the only passages for fuel from high pressure pump 40 are through orifices 22b. Flow of fuel from fuel chamber 35b continues until valve 36b seats and stops fuel from high pressure pump 40 from entering tip 20b. When actuator 48 is de-energized, actuator 58 may be energized, which opens valve 56 so that high pressure fuel in injector body 31b may pass into reservoir 50. Actuator 64 may also be energized alternatively or in combination with actuator 58, which opens valve 62 so that high pressure fuel in injector body 31b may flow into injector body 31a. Valve 36b lowers to its closed position, with or without opening of valves 56, 62. Reduction of pressure within injector body 31b when valves 56, 62 open augments movement of valve 36b to its closed position.

Injection through tip 20b ends when actuator 48 is de-energized, which closes valve 46 and stops fuel from high pressure pump 40 from entering tip 20b. When actuator 48 is de-energized, actuator 58 is energized, which opens valve 56 so that high pressure fuel in injector body 31b passes into reservoir 50. Actuator 64 may also be energized, which opens valve 62 so that high pressure fuel in injector body 31b passes into injector body 31a. Valve 36b also lowers to its closed position. Similar to the description above, reduction of pressure within injector body 31b when valves 56, 62 open augments movement of valve 36b to its closed position. When actuator 64 is de-energized and valve 62 is closed, pressure in chamber 35a is not affected by pressure changes in chamber 35b. With chamber 35a separated from chamber 35b by valve 62, actuator 44 may be energized before, during, or after fuel injection through orifices 22b so as to cause fuel injection through orifices 22a.

Fuel may be injected through injector tip 20a before, during, or after fuel is injected through injector tip 20b. Fuel may be injected multiple times through one injector tip 20a, 20b without intervening injection through the other injection tip during a compression and expansion cycle of the piston 21 within the cylinder 14. Whether from tip 20a or tip 20b, the first injection may be the main injection and the second injection may be the post injection. It will be appreciated that a pre-injection of fuel may precede the main injection of fuel. A quantity of fuel in the main injection may be larger than a quantity of fuel in a pre-injection, a post injection, or both.

The post injection may effectively reduce particular constituents of engine 12 emissions compared to systems that do not have a post injection. For example, controller 15 may open valve 46 shortly after opening valve 42 and before closing valve 42, such that the time windows for injection through tips 20a, 20b overlap. Alternatively, controller 15 may close valve 42 shortly before opening valve 46 such that the time windows for injection through tips 20a, 20b do not overlap. Alternatively still, controller 15 may open valve 46 before opening valve 42 such that fuel is injected into combustion chamber 13 first through tip 20b and then through tip 20a such that the time windows do or do not overlap. During opening and closing of valves 42, 46, 52, and 56, valve 62 may also be opened and closed via actuator 64 so as to optimize pressures within injector bodies 31a, 31b. By controlling separation of chamber 35a from chamber 35b using valve 62, cavitation within cylinder 13 may be minimized

Applicants discovered that a particular outlet orifice 22a conicity may be desirable at a particular engine speed or load, and that another outlet orifice 22b conicity may be desirable at another engine speed or load. Applicants also discovered that concentration of particular emissions constituents may be more sensitive to the conicity of the orifices delivering the main fuel injection than the conicity of the orifices delivering a pre-injection or a post-injection. Accordingly, engine 12 may be configured such that at one speed or load, tip 20a delivers the main injection and tip 20b delivers the post injection, and at another speed or load, tip 20b delivers the main injection and tip 20a delivers the post injection.

Valves 52, 56 that control flow to reservoir 50 may serve both damping and regulating functions for injector bodies 31a, 31b with or without active control of actuators 54, 58. Specifically, valves 52 and 56 may have a pressure limit such that whenever fuel pressure in injector bodies 31a, 31b is above a certain limit, valves 52, 56 open, respectively, without energizing actuators 54, 58. By providing these damping and regulating functions, valves 52, 56 may prolong the life of fuel injector apparatus 16.

It will be appreciated that the foregoing description provides examples of the disclosed systems and techniques. However, it is contemplated that other implementations of the disclosure may differ in detail from the foregoing examples. References to the disclosure or examples thereof are intended to reference the particular example being discussed at that point and are not intended to limit the scope of the disclosure more generally. Language of distinction with respect to certain features is intended to indicate a lack of preference for those features, but not to exclude such from the scope of the disclosure.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A fuel injection apparatus for use in a compression ignition engine, the fuel injection apparatus comprising:
a first injector tip defining a first set of outlet orifices therethrough; and
a second injector tip defining a second set of outlet orifices therethrough;
wherein the first set of outlet orifices has a first conicity and the second set of outlet orifices has a second conicity, and the first conicity is different from the second conicity.

2. The fuel injection apparatus of claim 1, wherein the first conicity is a neutral conicity and the second conicity is a converging conicity.

3. The fuel injection apparatus of claim 1, wherein the first conicity is a diverging conicity and the second conicity is a converging conicity.

4. The fuel injection apparatus of claim 1, wherein the first conicity is a neutral conicity and the second conicity is a diverging conicity.

5. An engine comprising:
an engine housing having at least one combustion chamber therein;
a piston movable within said at least one combustion chamber and configured to compress air therein to a compression ignition condition; and
a fuel injection apparatus defining at least a portion of said at least one combustion chamber, the fuel injection apparatus having a first injector tip defining a first set of outlet orifices therethrough and a second injector tip defining a second set of outlet orifices therethrough, the fuel injection apparatus being configured to selectively inject fuel into said combustion chamber via at least one of the first injector tip and the second injector tip,
wherein the first set of outlet orifices has a first conicity and the second set of outlet orifices has a second conicity, and the first conicity is different from the second conicity.

6. The engine of claim 5, wherein the first conicity is a neutral conicity and the second conicity is a converging conicity.

7. The engine of claim 5, wherein the first conicity is a diverging conicity and the second conicity is a converging conicity.

8. The engine of claim 5, wherein the first conicity is a neutral conicity and the second conicity is a diverging conicity.

9. The engine of claim 5 wherein an exhaust path of the engine does not include a diesel particulate filter.

10. The engine of claim 5 wherein the fuel injection apparatus further defines a first fuel chamber and a second fuel chamber,
wherein the first fuel chamber is in selective fluid communication with the first set of outlet orifices via a first valve, and the second fuel chamber is in selective fluid communication with the second set of outlet orifices via a second valve, and
wherein the first fuel chamber is in selective fluid communication with the second fuel chamber via a third valve.

11. The engine of claim 5, further comprising a controller operatively coupled to the fuel injection apparatus, the controller being configured to inject a first quantity of fuel into the at least one combustion chamber via the first set of outlet orifices; inject a second quantity of fuel into the combustion chamber via the second set of outlet orifices; and ignite the first quantity of fuel and the second quantity of fuel.

12. The engine of claim 5 wherein the fuel is injected as a liquid fuel.

13. A method of operating an internal combustion engine comprising the steps of:
injecting a first quantity of fuel into a combustion chamber of the engine via a first set of outlet orifices having a first conicity;
injecting a second quantity of fuel into the combustion chamber via a second set of outlet orifices having a second conicity, wherein the first conicity is different from the second conicity; and
igniting and burning the first quantity of fuel and the second quantity of fuel.

14. The method of claim 13, further comprising a step of exhausting combustion products from the combustion chamber to an ambient environment of the internal combustion engine, wherein the step of exhausting combustion products does not include passing the combustion products through a diesel particulate filter.

15. The method of claim 13, wherein the step of injecting the first quantity of fuel occurs before the step of injecting the second quantity of fuel.

16. The method of claim 13, wherein the step of injecting the second quantity of fuel occurs before the step of injecting the first quantity of fuel.

17. The method of claim 13, wherein the injecting steps are performed using a fuel injection apparatus that further defines a first fuel chamber and a second fuel chamber therein, wherein the first fuel chamber is in selective fluid communication with the first set of outlet orifices via a first valve, and the second fuel chamber is in selective fluid communication with the second set of outlet orifices via a second valve, and wherein the first fuel chamber is in selective fluid communication with the second fuel chamber via a third valve.

18. The method of claim 13, wherein the first quantity of fuel is larger than the second quantity of fuel while the internal combustion engine operates at a first speed, and the first quantity of fuel is smaller than the second quantity of fuel while the internal combustion engine operates at a second speed.

19. The method of claim 13, wherein the injecting the first quantity of fuel occurs before the injecting the second quantity of fuel while the internal combustion engine operates at a first speed, and the injecting the first quantity of fuel occurs after the injecting the second quantity of fuel while the internal combustion engine operates at a second speed.
